(19) United States
(12) Patent Application Publication
(10) Pub. No.: US 2023/0055930 A1
(43) Pub. Date: Feb. 23, 2023

(54) Low Noise Polymer Composition

(71) Applicant: Celanese Sales Germany GmbH, Sulzbach (DE)

(72) Inventors: Kirsten Markgraf, Weinheim (DE); Joachim Floeck, Brechan (DE)

(21) Appl. No.: 17/960,944

(22) Filed: Oct. 6, 2022

Related U.S. Application Data
(62) Division of application No. 16/027,849, filed on Jul. 5, 2018.
(60) Provisional application No. 62/529,200, filed on Jul. 6, 2017.

(51) Int. Cl. C08L 59/04; E05F 15/00; E05D 15/16; C08J 5/04; C08L 59/02; C08J 5/24

(52) U.S. Cl. CPC C08L 59/04; E05F 15/00; E05D 15/16; C08J 5/043; C08L 59/02; C08J 5/249; C08J 5/248; E05Y 2900/55; C08J 2359/02; C08J 2423/06; C08J 2483/04; C08J 2451/06; C08L 2205/03; C08L 2205/22; B60J 5/0419

(57) ABSTRACT

A tribologically modified polyoxymethylene polymer composition is disclosed. The polyoxymethylene polymer composition is comprised of a polyoxymethylene polymer, reinforcing fibers, and at least one tribological modifier. The tribological modifier, in one embodiment, can comprise a graft copolymer. The use of a graft copolymer has been found to unexpectedly and dramatically improve noise generation when tested against various substrates, especially glass substrates.

### RELATED APPLICATIONS

The present application is based upon and claims priority to U.S. Provisional Patent Application Ser. No. 62/529,200, filed on Jul. 6, 2017, which is incorporated herein by reference.

### BACKGROUND

Polyacetal polymers, which are commonly referred to as polyoxymethylene polymers, have become established as exceptionally useful engineering materials in a variety of applications. For instance, because polyoxymethylene polymers have excellent mechanical properties, fatigue resistance, abrasion resistance, chemical resistance, and moldability, they are widely used in constructing polymer articles, such as articles for use in the automotive industry and the electrical industry.

The mechanical properties of polyoxymethylene molding compositions are the reason for their use in numerous applications. To improve their properties, polyoxymethylene polymers are often provided with additives to adapt the properties for a specific application, for example by using reinforcing fibers or tribological modifiers. For instance, polyoxymethylene polymers have been combined with a tribological modifier for producing polymer compositions well suited for use in tribological applications where the polymer article is in moving contact with other articles, such as metal articles, plastic articles, and the like. These tribological applications can include embodiments where the polymer composition is formed into gear wheels, pulleys, sliding elements, and the like. The addition of a tribological modifier can provide a composition with a reduced coefficient of friction and low wear.

In the past, high molecular weight polyolefins have been used to improve the wear resistance of polyoxymethylene resins. For instance, U.S. Pat. No. 5,482,987, which is incorporated herein by reference in its entirety, discloses a self-lubricating, low wear composition containing a polyoxymethylene and a lubricating system comprising a high molecular weight polyethylene, a high density polyethylene, and other components. U.S. Pat. No. 5,641,824, which is incorporated herein by reference in its entirety, discloses a self-lubricating melt blend of a polyoxymethylene and an ultra-high molecular weight polyethylene.

In addition to high molecular weight polyolefins, numerous other tribological modifiers have been proposed in the past. For instance, other tribological modifiers that have been used in the past include silicones such as silicone oil, polytetrafluoroethylene particles, waxes, and the like. Each tribological modifier can display different properties depending upon the particular application. Thus, the use of tribological modifiers in particular applications has been somewhat unpredictable.

In certain applications, in addition to reducing the coefficient of friction and reducing wear, it is desirable that the polymer composition also produce little to no noise when moving or sliding against an adjacent surface which has been found to produce difficulties when formulating a composition for a particular application. Although many tribological modifiers can produce compositions having low friction characteristics, the compositions can still have a tendency to produce unacceptable levels of noise when moving against certain adjacent materials. Thus, finding a tribological modifier that not only reduces the coefficient of friction but also eliminates noise generation has been problematic. In this regard, the present disclosure is directed to polymer compositions that have reduced noise properties when in active motion and in contact with an adjacent surface.

### SUMMARY

According to one embodiment, the present disclosure is directed to a polymer composition. The composition is comprised of a polyoxymethylene polymer, reinforcing fibers, and a tribological modifier comprising a graft copolymer. It was discovered that the graft copolymer of the present disclosure produces extreme low levels of noise when present in the polymer composition and the composition is tested against various materials, such as glass. The composition, for instance, is particularly well suited for use in vehicle window systems for stabilizing the window during raising and lowering.

In one embodiment, the graft copolymer comprises a copolymer of a polyolefin or polycarbonate and a branch polymer. The polyolefin, for instance, may comprise a polyethylene or polypropylene. The branch polymer, on the other hand, may comprise a styrenic polymer, an acrylonitrile polymer, a vinyl polymer, and/or an ether polymer. In one particular embodiment, the branch polymer comprises a styrene acrylonitrile polymer. The graft copolymer can be present in the polymer composition in an amount of at least about 2% by weight, such as from about 3% to about 7% by weight.

In one embodiment, the graft copolymer is the only tribological modifier present in the polymer composition. In other embodiments, however, the composition may contain ultra-high molecular weight polyethylene particles and/or ultra-high molecular weight silicone.

The graft copolymer is particularly well suited for use in polymer compositions containing a polyoxymethylene polymer. The polyoxymethylene polymer can have reactive groups at terminal positions on the polymer. For example, the reactive groups may comprise hydroxy groups. In addition to the polyoxymethylene polymer, the polymer composition may contain reinforcing fibers and a coupling agent. The reinforcing fibers may be present in the polymer composition in an amount from about 5% to about 55% by weight. The coupling agent may be configured to couple the polyoxymethylene polymer to the reinforcing fibers.

The polymer composition of the present disclosure has excellent low friction properties while also producing extremely low amounts of noise, especially when tested against glass, such as car glass and other glass used to produce vehicles. For instance, when tested against glass, the composition can have a noise rating of less than 4. In addition, the composition can have a dynamic coefficient of friction when tested according to VDA 230-206 of less than about 0.4, such as less than about 0.35, such as from about 0.15 to about 0.35. When tested according to VDA 230-206, the polymer composition can also exhibit a wear track of less than 50 microns against a glass surface.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of one embodiment of a window lift system for a vehicle that may include components made according to the present disclosure.

Repeat use of reference characters in the present specification and drawings is intended to represent the same or analogous features or elements of the present invention.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations.

In general, the present disclosure is directed to a polyoxymethylene polymer composition and to polymer articles made from the composition. The polymer composition contains a polyoxymethylene polymer and has improved tribological properties such as reduced noise generation properties. Of particular advantage, the polymer composition of the present disclosure produces extremely low levels of noise when tested against various substrates, such as glass. In fact, in certain embodiments, the polymer composition of the present disclosure, when molded into articles, can be incorporated into glass contacting applications without producing any audible noise.

In one particular embodiment, the polymer composition of the present disclosure includes a polyoxymethylene polymer that contains reactive or functional groups at terminal positions on the polymer chain. The polyoxymethylene polymer may be combined with reinforcing fibers and a coupling agent. The coupling agent couples the reinforcing fibers to the polymer matrix. The improved adhesion between the fibers and the polymer matrix results in a composition having improved mechanical properties, including tribological properties. In order to further improve the tribological properties of the polymer composition, the composition can then contain a tribological modifier. In one embodiment, the tribological modifier comprises a graft copolymer. For instance, the graft copolymer can be a copolymer of a polyolefin or polycarbonate and a branch polymer. The graft copolymer can be present alone or in combination with other tribological modifiers. In one embodiment, however, the graft copolymer is the only tribological modifier contained in the polymer composition. Use of the graft copolymer has been found to lead to dramatically improved low noise properties, especially when the composition is molded into parts that contact other materials, such as metals and glass.

### Polyoxymethylene Polymer

According to the present disclosure, the polyoxymethylene polymer composition comprises a polyoxymethylene polymer.

The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. The polyoxymethylene polymer used in the polymer composition may comprise a homopolymer or a copolymer. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.1 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

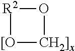

in which x is 0 or 1 and R² is a C₂-C₄-alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.5 to 5 mol. %, such as from 0.5 to 4 mol. %, of one of the above-mentioned comonomers.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

In one embodiment, the polyoxymethylene polymer used in the polymer composition may contain a relatively high amount of reactive groups or functional groups in the terminal position. The reactive groups or functional groups can comprise any groups that are capable of forming a bond with a coupling agent. The reactive groups, for instance, may comprise —OH or —NH₂ groups.

In one embodiment, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 15 mmol/kg, such as at least 18 mmol/kg, such as at least 20 mmol/kg. In one embodiment, the terminal hydroxyl group content ranges from 18 to 50 mmol/kg. In an alternative embodiment, the polyoxymethylene polymer may contain terminal hydroxyl groups in an amount less than 20 mmol/kg, such as less than 18 mmol/kg, such as less than 15 mmol/kg. For instance, the polyoxymethylene polymer may contain terminal hydroxyl groups in an amount from about 5 mmol/kg to about 20 mmol/kg, such as from about 5 mmol/kg to about 15 mmol/kg. For example, a polyoxymethylene polymer may be used that has a lower terminal hydroxyl group content but has a higher melt volume flow rate.

In addition to the terminal hydroxyl groups, the polyoxymethylene polymer may also have other terminal groups usual for these polymers. Examples of these are alkoxy groups, formate groups, acetate groups or aldehyde groups. According to one embodiment, the polyoxymethylene is a homo- or copolymer which comprises at least 50 mol %, such as at least 75 mol-%, such as at least 90 mol-% and such as even at least 95 mol-% of —CH₂O-repeat units.

In addition to having a relatively high terminal hydroxyl group content, the polyoxymethylene polymer according to the present disclosure can also have a relatively low amount of low molecular weight constituents. As used herein, low molecular weight constituents (or fractions) refer to constituents having molecular weights below 10,000 dalton. In order to produce a polymer having the desired permeability requirements, the present inventors unexpectedly discovered that reducing the proportion of low molecular weight constituents can dramatically improve the permeability properties of the resulting material, when attached to an impact modifier. In this regard, the polyoxymethylene polymer contains low molecular weight constituents in an amount less than about 10% by weight, based on the total weight of the polyoxymethylene. In certain embodiments, for instance, the polyoxymethylene polymer may contain low molecular weight constituents in an amount less than about 5% by weight, such as in an amount less than about 3% by weight, such as even in an amount less than about 2% by weight.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2 wt. %.

A heteropoly acid refers to polyacids formed by the condensation of different kinds of oxo acids through dehydration and contains a mono- or poly-nuclear complex ion wherein a hetero element is present in the center and the oxo acid residues are condensed through oxygen atoms. Such a heteropoly acid is represented by the formula:

Hₓ[MmM′nOz]_{y}H₂O

wherein

M represents an element selected from the group consisting of P, Si, Ge, Sn, As, Sb, U, Mn, Re, Cu, Ni, Ti, Co, Fe, Cr, Th or Ce,

M′ represents an element selected from the group consisting of W, Mo, V or Nb,

m is 1 to 10,

n is 6 to 40,

z is 10 to 100,

x is an integer of 1 or above, and

y is 0 to 50.

The central element (M) in the formula described above may be composed of one or more kinds of elements selected from P and Si and the coordinate element (M′) is composed of at least one element selected from W, Mo and V, particularly W or Mo.

Specific examples of heteropoly acids are phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstovanadic acid and acid salts thereof. Excellent results have been achieved with heteropoly acids selected from 12-molybdophosphoric acid (H₃PMo₁₂O₄₀) and 12-tungstophosphoric acid (H₃PW₁₂O₄₀) and mixtures thereof.

The heteropoly acid may be dissolved in an alkyl ester of a polybasic carboxylic acid. It has been found that alkyl esters of polybasic carboxylic acid are effective to dissolve the heteropoly acids or salts thereof at room temperature (25° C.).

The alkyl ester of the polybasic carboxylic acid can easily be separated from the production stream since no azeotropic mixtures are formed. Additionally, the alkyl ester of the polybasic carboxylic acid used to dissolve the heteropoly acid or an acid salt thereof fulfills the safety aspects and environmental aspects and, moreover, is inert under the conditions for the manufacturing of oxymethylene polymers.

Preferably the alkyl ester of a polybasic carboxylic acid is an alkyl ester of an aliphatic dicarboxylic acid of the formula:

(ROOC)—(CH₂)n—(COOR′)

wherein

n is an integer from 2 to 12, preferably 3 to 6 and

R and R′ represent independently from each other an alkyl group having 1 to 4 carbon atoms, preferably selected from the group consisting of methyl, ethyl, n-propyl, iso-propyl, n-butyl, iso-butyl and tert.-butyl.

In one embodiment, the polybasic carboxylic acid comprises the dimethyl or diethyl ester of the above-mentioned formula, such as a dimethyl adipate (DMA).

The alkyl ester of the polybasic carboxylic acid may also be represented by the following formula:

(ROOC)₂—CH—(CH₂)m—CH—(COOR′)₂

wherein

m is an integer from 0 to 10, preferably from 2 to 4 and

R and R′ are independently from each other alkyl groups having 1 to 4 carbon atoms, preferably selected from the group consisting of methyl, ethyl, n-propyl, iso-propyl, n-butyl, iso-butyl and tert.-butyl.

Particularly preferred components which can be used to dissolve the heteropoly acid according to the above formula are butantetracarboxylic acid tetratethyl ester or butantetracarboxylic acid tetramethyl ester.

Specific examples of the alkyl ester of a polybasic carboxylic acid are dimethyl glutaric acid, dimethyl adipic acid, dimethyl pimelic acid, dimethyl suberic acid, diethyl glutaric acid, diethyl adipic acid, diethyl pimelic acid, diethyl suberic acid, diemethyl phthalic acid, dimethyl isophthalic acid, dimethyl terephthalic acid, diethyl phthalic acid, diethyl isophthalic acid, diethyl terephthalic acid, butantetracarboxylic acid tetramethylester and butantetracarboxylic acid tetraethylester as well as mixtures thereof. Other examples include dimethylisophthalate, diethylisophthalate, dimethylterephthalate or diethylterephthalate.

Preferably, the heteropoly acid is dissolved in the alkyl ester of the polybasic carboxylic acid in an amount lower than 5 wt. %, preferably in an amount ranging from 0.01 to 5 wt. %, wherein the weight is based on the entire solution.

In some embodiments, the polymer composition of the present disclosure may contain other polyoxymethylene homopolymers and/or polyoxymethylene copolymers. Such polymers, for instance, are generally unbranched linear polymers which contain at least 80%, such as at least 90%, oxymethylene units.

The polyoxymethylene polymer can have any suitable molecular weight. The molecular weight of the polymer, for instance, can be from about 4,000 grams per mole to about 20,000 g/mol. In other embodiments, however, the molecular weight can be well above 20,000 g/mol, such as from about 20,000 g/mol to about 100,000 g/mol.

The polyoxymethylene polymer present in the composition can generally melt flow index (MFI) ranging from about 1 to about 50 g/10 min, as determined according to ISO 1133 at 190° C. and 2.16 kg, though polyoxymethylenes having a higher or lower melt flow index are also encompassed herein. For example, the polyoxymethylene polymer may be a low or mid-molecular weight polyoxymethylene that has a melt flow index of greater than about 5 g/10 min, greater than about 10 g/10 min, or greater than about 15 g/10 min. The melt flow index of the polyoxymethylene polymer can be less than about 25 g/10 min, less than about 20 g/10 min, less than about 18 g/10 min, less than about 15 g/10 min, less than about 13 g/10 min, or less than about 12 g/10 min. The polyoxymethylene polymer may for instance be a high molecular weight polyoxymethylene that has a melt flow index of less than about 5 g/10 min, less than about 3 g/10 min, or less than about 2 g/10 min.

Suitable commercially available polyoxymethylene polymers are available under the trade name Hostaform® (HF) by Celanese/Ticona.

The polyoxymethylene polymer may be present in the polyoxymethylene polymer composition in an amount of at least 50 wt. %, such as at least 60 wt. %, such as at least 70 wt. %, such as at least 80 wt. %, such as at least 85 wt. %, such as at least 90 wt. %, such as at least 95 wt. %. In general, the polyoxymethylene polymer is present in an amount of less than about 100 wt. %, such as less than about 99 wt. %, such as less than about 97 wt. %, wherein the weight is based on the total weight of the polyoxymethylene polymer composition.

### Reinforcing Fibers

In one embodiment, the polymer composition may contain reinforcing fibers.

Reinforcing fibers of which use may advantageously be made are mineral fibers, such as glass fibers, polymer fibers, in particular organic high-modulus fibers, such as aramid fibers, or metal fibers, such as steel fibers, or carbon fibers or natural fibers, fibers from renewable resources.

These fibers may be in modified or unmodified form, e.g. provided with a sizing, or chemically treated, in order to improve adhesion to the plastic. Glass fibers are particularly preferred.

Glass fibers are provided with a sizing to protect the glassfiber, to smooth the fiber but also to improve the adhesion between the fiber and the matrix material. A sizing usually comprises silanes, film forming agents, lubricants, wetting agents, adhesive agents optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are for example polyvinylacetates, polyesters and polyurethanes. Sizings based on polyurethanes may be used advantageously.

The reinforcing fibers may be compounded into the polyoxymethylene matrix, for example in an extruder or kneader. However, the reinforcing fibers may also advantageously take the form of continuous-filament fibers sheathed or impregnated with the polyoxymethylene molding composition in a process suitable for this purpose, and then processed or wound up in the form of a continuous strand, or cut to a desired pellet length so that the fiber lengths and pellet lengths are identical. An example of a process particularly suitable for this purpose is the pultrusion process.

According to the invention, the long-fiber-reinforced polyoxymethylene molding composition may be a glass-fiber bundle which has been sheathed with one or more layers of the polyoxymethylene matrix polymer in such a way that the fibers have not been impregnated and mixing of the fibers and the polyacetal matrix polymer does not take place until processing occurs, for example injection molding. However, the fibers have advantageously been impregnated with the polyacetal matrix polymer.

According to a preferred embodiment, the molding composition of the present invention comprises at least one reinforcing fiber which is a mineral fiber, preferably a glass fiber, more preferably a coated or impregnated glass fiber. Glass fibers which are suitable for the molding composition of the present invention are commercially available, e.g. Johns Manville, ThermoFlow®Chopped Strand 753, OCV Chopped Strand 408 A, Nippon Electric Glass Co. (NEG) Chopped Strand T-651.

Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 15 μm. When present, the respective composition may contain reinforcing fibers in an amount of at least 1 wt. %, such as at least 5 wt. %, such as at least 7 wt. %, such as at least 10 wt. %, such as at least 15 wt. % and generally less than about 50 wt. %, such as less than about 45 wt. %, such as less than about 40 wt. %, such as less than about 30 wt. %, such as less than about 20 wt. %, wherein the weight is based on the total weight of the respective polyoxymethylene polymer composition.

### Coupling Agent

In one embodiment, a coupling agent may be present. Coupling agents used include polyfunctional coupling agents, such as trifunctional or bifunctional agents. A suitable coupling agent is a polyisocyanate such as a diisocyanate. The coupling agent may provide a linkage between the polyoxymethylene polymer and the reinforcing fiber and/or sizing material coated on the reinforcing fiber. Generally, the coupling agent is present in an amount of at least about 0.1 wt. %, such as at least about 0.2 wt. % such as at least about 0.3 wt. % and less than about 5 wt. %, such as less than about 3 wt. %, such as less than about 1.5 wt. %. Alternatively, the composition may also be substantially free of any coupling agents such as less than about 0.2 wt. %, such as less than about 0.1 wt. %, such as less than about 0.05 wt. %, such as less than about 0.01 wt. %, such as about 0 wt. %.

A suitable coupling agent is a polyisocyanate, preferably organic diisocyanate, more preferably a polyisocyanate selected from the group consisting of aliphatic diisocyanates, cycloaliphatic diisocyanates, aromatic diisocyanates and mixtures thereof.

Preferred are polyfunctional coupling agents, such as trifunctional or bifunctional agents.

Preferably, the polyisocyanate is a diisocyanate or a triisocyanate which is more preferably selected from 2,2′-, 2,4′-, and 4,4′-diphenylmethane diisocyanate (MDI); 3,3′-dimethyl-4,4′-biphenylene diisocyanate (TODD; toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate, 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate, dicyclohexylmethane diisocyanate; cyclobutane-1,3-diisocyanate; cyclohexane-1,2-diisocyanate; cyclohexane-1,3-diisocyanate, cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis (isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chiorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

Especially preferred are aromatic polyisocyanates, such as 4,4′-diphenylmethane diisocyanate (MDI).

### Tribological Modifier

According to the present disclosure, the polyoxymethylene polymer composition and the polymer article comprising the polyoxymethylene polymer composition may comprise at least one tribological modifier. For instance, in one embodiment, the tribological modifier comprises a graft copolymer. The graft copolymer has been found to dramatically reduce noise generation when incorporated into the polymer composition and parts made from the composition are contacted with other materials. The graft copolymer is particularly well suited for reducing noise when the composition is contacted with glass and metals. In this regard, the composition of the present disclosure is particularly well suited for producing sliding members in all different types of applications.

In general, the graft copolymer contains a main chain polymer and a branch polymer. The branch polymer forms branches off of the main chain polymer. The main chain polymer may comprise, for instance, a polyolefin or polycarbonate polymer. The polyolefin polymer, for instance, may comprise polyethylene and/or polypropylene homopolymers and copolymers. The main chain polymer may comprise, for instance, ethylene and propylene random copolymers. For instance, the main chain polymer may comprise an alpha-olefin copolymer or interpolymer. Examples of main chain polymers include ethylene and butene copolymers, ethylene and octene copolymers, and/or ethylene/glycidyl (meth)acrylate copolymers.

The branch polymer incorporated into the graft copolymer, on the other hand, may comprise any suitable branching polymer. For instance, the branching polymer may comprise a vinyl polymer and/or an ether polymer. Examples of branch polymers include styrenic polymers, acrylonitrile polymers, and styrene acrylonitrile polymers. The branch polymer may be derived from ethylenically unsaturated monomers, such as ethylenically unsaturated carboxylic acids. In one particular embodiment, for instance, the branch polymer may comprise a (meth)acrylic polymer.

In one particular embodiment, the graft copolymer may comprise a copolymer of a polyolefin, such as polyethylene or polypropylene, and a styrenic polymer, such as a styrene acrylonitrile polymer. In an alternative embodiment, the graft copolymer may comprise a copolymer of methyl methacrylate and styrene.

The amount of graft copolymer contained within the polymer composition can vary depending upon different factors including the particular application for which the composition is to be used. For instance, the amount of graft copolymer contained in the composition can depend upon the required properties of the molded part and the type of materials that the part will contact during use. In general, the graft copolymer is present in the polymer composition in an amount greater than about 2% by weight, such as in an amount greater than about 3% by weight, such as in an amount greater than about 4% by weight, such as in an amount greater than about 5% by weight, such as in an amount greater than about 7% by weight. The graft copolymer is present in the composition in an amount generally less than about 10% by weight, such as in an amount less than about 8% by weight, such as in an amount less than about 7% by weight, such as in an amount less than about 6% by weight, such as in an amount less than about 5% by weight. In one embodiment, the graft copolymer is the only tribological modifier present in the polymer composition. In one embodiment, for instance, the polymer composition of the present disclosure is silicone free and does not contain any silicone oils or compounds.

In an alternative embodiment, however, the graft copolymer may be combined with a silicone within the polymer composition. The silicone, for instance, may comprise an ultra-high molecular weight silicone.

In general, the UHMW-Si may have an average molecular weight of greater than about 100,000 g/mol, such as greater than about 200,000 g/mol, such as greater than about 300,000 g/mol, such as greater than 500,000 g/mol and less than about 5,000,000 g/mol, such as less than about 3,000,000 g/mol, such as less than about 2,000,000 g/mol, such as less than about 1,000,000 g/mol, such as less than about 500,000 g/mol, such as less than about 300,000 g/mol. Generally, the UHMW-Si may have a kinematic viscosity at 40° C. measured according to DIN 51562 of greater than about 100,000 mm² s⁻¹, such as greater than about 200,000 mm² s⁻¹, such as greater than about 1,000,000 mm² s⁻¹, such as greater than about 5,000,000 mm² s⁻¹, such as greater than about 10,000,000 mm² s⁻¹, such as greater than about 15,000,000 mm² s⁻¹ and less than about 50,000,000 mm² s⁻¹, such as less than about 25,000,000 mm² s⁻¹, such as less than about 10,000,000 mm² s⁻¹, such as less than about 1,000,000 mm² s⁻¹, such as less than about 500,000 mm² s⁻¹, such as less than about 200,000 mm² s⁻¹.

The UHMW-Si may comprise a siloxane such as a polysiloxane or polyorganosiloxane. In one embodiment, the UHMW-Si may comprise a dialkylpolysiloxane such as a dimethylsiloxane, an alkylarylsiloxane such as a phenylmethylsilaoxane, or a diarylsiloxane such as a diphenylsiloxane, or a homopolymer thereof such as a polydimethylsiloxane or a polymethylphenylsiloxane, or a copolymer thereof with the above molecular weight and/or kinematic viscosity requirements. The polysiloxane or polyorganosiloxane may also be modified with a substituent such as an epoxy group, a hydroxyl group, a carboxyl group, an amino group or a substituted amino group, an ether group, or a meth(acryloyl) group in the end or main chain of the molecule. The UHMW-Si compounds may be used singly or in combination. Any of the above UHMW-Si compounds may be used with the above molecular weight and/or kinematic viscosity requirements.

The UHMW-Si may be added to the polyoxymethylene polymer composition as a masterbatch wherein the UHMW-Si is dispersed in a polyoxymethylene polymer and the masterbatch is thereafter added to another polyoxymethylene polymer. The masterbatch may comprise from about 10 wt. % to about 50 wt. %, such as from about 35 wt. % to about 45 wt. %, such as about 40 wt. % of an UHMW-Si.

The UHMW-Si may be present in the polyoxymethylene polymer composition in an amount of at greater than about 0 wt. %, such as at greater than about 0.1 wt. %, such as at greater than about 0.5 wt. %, such as at greater than about 0.75 wt. %, such as at greater than about 1 wt. %, such as at greater than about 2 wt. %, such as at greater than about 2.5 wt. % and generally less than about 10 wt. %, such as less than about 7 wt. %, such as less than about 6 wt. %, such as less than about 5 wt. %, such as less than about 4 wt. %, such as less than about 3 wt. %, wherein the weight is based on the total weight of the polyoxymethylene polymer composition.

In an alternative embodiment, the polymer composition may contain an ultra-high molecular weight polyethylene (UHMW-PE) powder. UHMW-PE can be employed as a powder, in particular as a micro-powder. The UHMW-PE generally has a mean particle diameter D₅₀ (volume based and determined by light scattering) in the range of 1 to 5000 μm, preferably from 10 to 500 μm, and particularly preferably from 10 to 150 μm such as from 30 to 130 μm, such as from 80 to 150 μm, such as from 30 to 90 μm.

The UHMW-PE can have an average molecular weight of higher than 1.0·10⁶ g/mol, such as higher than 2.0·10⁶ g/mol, such as higher than 4.0·10⁶ g/mol, such as ranging from 1.0·10⁶ g/mol to 15.0·10⁶ g/mol, such as from 3.0·10⁶ g/mol to 12.0·10⁶ g/mol, determined by viscosimetry. Preferably, the viscosity number of the UHMW-PE is higher than 1000 ml/g, such as higher than 1500 ml/g, such as ranging from 1800 ml/g to 5000 ml/g, such as ranging from 2000 ml/g to 4300 ml/g (determined according to ISO 1628, part 3; concentration in decahydronaphthalin: 0.0002 g/ml).

When present, the ultra-high molecular weight polyethylene powder can be contained in the composition generally in an amount greater than about 2% by weight, such as in an amount greater than about 3% by weight, such as in an amount greater than about 4% by weight, such as in an amount greater than about 5% by weight. The ultra-high molecular weight polyethylene powder is generally present in an amount less than about 10% by weight, such as in an amount less than about 9% by weight, such as in an amount less than about 8% by weight, such as in an amount less than about 7% by weight, such as in an amount less than about 6% by weight, such as in an amount less than about 5% by weight.

According to the present disclosure, tribological modifiers improve the tribological properties of the polyoxymethylene polymer compositions and polymer articles produced therefrom without the need for an external lubricant, such as water-based or PTFE-based external lubricants, when utilized in tribological applications. An external lubricant may be a lubricant that is applied to a polymer article or polyoxymethylene based system of the present disclosure. In one embodiment, an external lubricant may not be associated with the polyoxymethylene polymer composition or polymer article such that the external lubricant is not present on a surface of the polyoxymethylene polymer composition or polymer article. In another embodiment, an external lubricant may be utilized with the polyoxymethylene polymer composition and polymer article of the present disclosure.

### Other Additives

The polymer composition of the present disclosure may also contain other known additives such as, for example, antioxidants, formaldehyde scavengers, acid scavengers, UV stabilizers or heat stabilizers, reinforcing fibers. In addition, the compositions can contain processing auxiliaries, for example adhesion promoters, lubricants, nucleants, demolding agents, fillers, or antistatic agents and additives which impart a desired property to the compositions and articles or parts produced therefrom.

In one embodiment, an ultraviolet light stabilizer may be present. The ultraviolet light stabilizer may comprise a benzophenone, a benzotriazole, or a benzoate. The UV light absorber, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a formaldehyde scavenger, such as a nitrogen-containing compound, may be present. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Other particularly advantageous compounds are triamino-1,3,5-triazine (melamine) and its derivatives, such as melamine-formaldehyde condensates and methylol melamine. Oligomeric polyamides are also suitable in principle for use as formaldehyde scavengers. The formaldehyde scavenger may be used individually or in combination.

Further, the formaldehyde scavenger may be a guanamine compound which may include an aliphatic guanamine-based compound, an alicyclic guanamine-based compound, an aromatic guanamine-based compound, a hetero atom-containing guanamine-based compound, or the like. The formaldehyde scavenger may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, an acid scavenger may be present. The acid scavenger may comprise, for instance, an alkaline earth metal salt. For instance, the acid scavenger may comprise a calcium salt, such as a calcium citrate. The acid scavenger may be present in an amount of at least about 0.001 wt. %, such as at least about 0.005 wt. %, such as at least about 0.0075 wt. % and less than about 1 wt. %, such as less than about 0.75 wt. %, such as less than about 0.5 wt. %, wherein the weight is based on the total weight of the respective polymer composition.

In one embodiment, a nucleant may be present. The nucleant may increase crystallinity and may comprise an oxymethylene terpolymer. In one particular embodiment, for instance, the nucleant may comprise a terpolymer of butanediol diglycidyl ether, ethylene oxide, and trioxane. The nucleant may be present in the composition in an amount of at least about 0.01 wt. %, such as at least about 0.05 wt. %, such as at least about 0.1 wt. % and less than about 2 wt. %, such as less than about 1.5 wt. %, such as less than about 1 wt. %, wherein the weight is based on the total weight of the respective polymer composition.

In one embodiment, an antioxidant, such as a sterically hindered phenol, may be present. Examples which are available commercially, are pentaerythrityl tetrakis[3-(3,5-di-tert-butyl-4-hydroxyphenyl)propionate], triethylene glycol bis[3-(3-tert-butyl-4-hydroxy-5-methylphenyl)propionate], 3,3′-bis[3-(3,5-di-tert-butyl-4-hydroxyphenyl)propionohydrazide], and hexamethylene glycol bis[3-(3,5-di-tert-butyl-4-hydroxyphenyl)propionate]. The antioxidant may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lights stabilizers, such as sterically hindered amines, may be present in addition to the ultraviolet light stabilizer. Hindered amine light stabilizers that may be used include oligomeric hindered amine compounds that are N-methylated. For instance, hindered amine light stabilizer may comprise a high molecular weight hindered amine stabilizer. The light stabilizers, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lubricants may be present. The lubricant may comprise a polymer wax composition. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. In another embodiment, a fatty acid amide such as ethylene bis(stearamide) may be present. Lubricants may generally be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a compatibilizer, such as a phenoxy resin, may be present. Generally, the phenoxy resin may be present in the composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a colorant may be present. Colorants that may be used include any desired inorganic pigments, such as titanium dioxide, ultramarine blue, cobalt blue, and other organic pigments and dyes, such as phthalocyanines, anthraquinnones, and the like. Other colorants include carbon black or various other polymer-soluble dyes. The colorant may be present in the composition in an amount of at least about 0.01 wt. %, such as at least about 0.05 wt. %, such as at least about 0.1 wt. % and less than about 5 wt. %, such as less than about 2.5 wt. %, such as less than about 1 wt. %, wherein the weight is based on the total weight of the respective polymer composition.

### Polymer Articles

The compositions of the present disclosure can be compounded and formed into a polymer article using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 100 to 280° C., such as from 120 to 260° C., such as from 140 to 240° C. or 180 to 220° C.

After extrusion, the compositions may be formed into pellets. The pellets can be molded into polymer articles by techniques known in the art such as injection molding, thermoforming, blow molding, rotational molding and the like. According to the present disclosure, the polymer articles demonstrate excellent tribological behavior and mechanical properties. Consequently, the polymer articles can be used for several applications where low wear and excellent gliding properties are desired.

Polymer articles include any moving articles or moldings that are in contact with another surface and may require high tribological requirements. For instance, polymer articles include articles for the automotive industry, especially housings, latches such as rotary latches, window winding systems, wiper systems, pulleys, sun roof systems, seat adjustments, levers, bushes, gears, gear boxes, claws, pivot housings, wiper arms, brackets or seat rail bearings, zippers, switches, cams, rollers or rolling guides, sliding elements or glides such as sliding plates, conveyor belt parts such as chain elements and links, castors, fasteners, levers, conveyor system wear strips and guard rails, medical equipment such as medical inhalers and injectors. An almost limitless variety of polymer articles may be formed from the polymer compositions of the present disclosure.

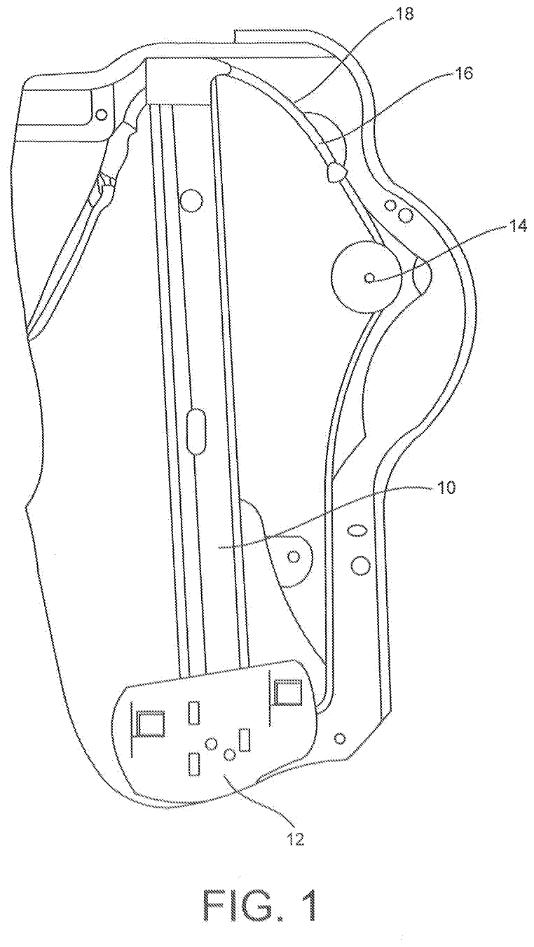

In one embodiment, polymer articles made in accordance with the present disclosure can be used in a window lift system as shown in FIG. 1. The window lift system is for raising and lowering a window glass. The window glass can be installed, for instance, in a door of a motor vehicle. The window glass, however, can be installed in any suitable window frame whether the frame is contained in a vehicle or in a stationary structure.

In FIG. 1, one exemplary embodiment of a window lift system is illustrated. The window lift system includes a rail 10 that defines a track. Within the track is a glass carrier 12. The glass carrier 12 is for receiving the window glass and is mounted for movement along the track. The system further includes a motor 14 in operative association with a cable 16. The cable is attached to the carrier 12. The motor or drive unit engages the cable to move the glass carrier along the track for opening and closing the window. The cable 16 can be contained within a sheath 18.

The glass carrier 12 can include some type of clamping device for engaging the lower end of a window glass.

In accordance with the present disclosure, various components contained within the window lift system can be made from the polymer composition. For instance, at least a portion of the carrier 12 can be made from the polymer composition. In one embodiment, for instance, the entire carrier 12 is made from the polymer composition.

In addition to the carrier 12, one or more pulleys contained within the system and the sheath or liner 18 for the cable 16 can be made from the polymer composition. These components not only come into direct contact with the window glass and other components in the system but can also be contained in a thermally stressed environment. Of particular advantage, the polymer composition of the present disclosure can be incorporated into the window lift system without creating unwanted noise while also having excellent mechanical properties for withstanding repeated stress.

### Properties

Utilizing the polyoxymethylene polymer composition and polymer article produced therefrom according to the present disclosure provides compositions and articles with improved tribological properties. According to the present disclosure, the tribological properties are generally measured by the coefficient of friction.

In general, static friction is the friction between two or more surfaces that are not moving relative to each other (ie., both objects are stationary). In general, dynamic friction occurs when two objects are moving relative to each other (ie., at least one object is in motion or repeated back and forth motion). In addition, stick-slip is generally known as a phenomenon caused by continuous alternating between static and dynamic friction.

According to the present disclosure, the composition and polymer article may exhibit a dynamic coefficient of friction against car glass, as determined according to VDA 230-206, of generally less than about 0.4, such as less than about 0.35, such as less than about 0.3, such as less than about 0.25. The dynamic coefficient of friction against car glass is generally greater than about 0.05, such as greater than about 0.1, such as greater than about 0.15, such as greater than about 0.2. Standard car glass is made of laminated safety glass. Car glass includes two curved sheets of glass with a plastic layer laminated between them. The above dynamic coefficient of friction is measured with a force of 30 N, a velocity of 8 mm/s, and after 1,000 cycles.

During the test according to VDA 230-206, the depth of wear in the countermaterial can also be measured. Polymer compositions according to the present disclosure when tested against car glass may exhibit a depth of wear of less than about 150 microns, such as less than about 100 microns, such as less than about 50 microns. The depth of wear is generally greater than 1 micron. In one embodiment, the depth of wear can be from about 10 microns to about 40 microns.

While the polyoxymethylene polymer composition and polymer articles produced therefrom of the present invention provide improved tribological properties, the compositions and articles may also exhibit excellent mechanical properties. For example, when tested according to ISO Test No. 527, the polymer composition may have a tensile modulus of greater than about 5,000 MPa, such as greater than about 5,500 MPa, such as greater than about 5,700 MPa. The tensile modulus is generally less than about 10,000 MPa. In one embodiment, the strength at break can be greater than about 100 MPa, such as greater than about 110 MPa. In one embodiment, the strength at break can be from about 110 MPa to about 120 MPa. The strain at break is generally greater than about 3.25%, such as greater than about 3.4%. The strain at break is generally less than about 5%. In one embodiment, the strain at break can be from about 3.6% to about 5%.

The polymer composition can exhibit a notched Charpy impact strength at 23° C. of greater than about 8 kJ/m², such as greater than about 9 kJ/m², such as greater than about 9.5 kJ/m². The notched Charpy impact strength is generally less than about 15 kJ/m².

The polymer composition can exhibit a melt volume ratio of from about 0.5 cm³/10 min to about 5 cm³/10 min in certain embodiments. In one embodiment, the melt volume ratio is from about 1.5 cm³/10 min to about 2 cm³/10 min. Melt volume ratio can be measured at 190° C. and at a load of 2.16 kilograms.

The polymer composition can also exhibit a heat distortion temperature of greater than about 150° C., such as greater than about 155° C., such as greater than about 160° C. In one embodiment, the heat distortion temperature can be from about 155° C. to about 165° C. The heat distortion temperature can be measured at 1.8 MPa according to ISO Test 72-2.

The present disclosure may be better understood with reference to the following examples.

### Example

In this example, various polymer compositions were formulated and tested for mechanical properties, including tribological properties.

The polymer composition contained a polyoxymethylene polymer combined with glass fiber, a coupling agent, and at least one tribological modifier. In addition, the polymer compositions contained other conventional additives which included a nucleating agent, an antioxidant, and a melamine formaldehyde scavenger. The polyoxymethylene polymer included reactive or functional terminal groups. The reactive groups comprised hydroxide groups. Greater than 50% of the terminal groups comprise the hydroxide groups on the polymer. The polyoxymethylene polymer contained terminal hydroxide groups in an amount from about 20 mmol/kg to about 25 mmol/kg. The polyoxymethylene polymer was a copolymer containing 3.4 wt. % dioxolane comonomer.

The coupling agent used was MDI and the glass fibers included a sizing agent.

The components of each respective composition were mixed together and compounded using a ZSK 25MC (Werner & Pfleiderer, Germany) twin screw extruder (zone temperature 190° C., melt temperature about 210° C.). The screw configuration with kneading elements was chosen so that effective thorough mixing of the components took place. The compositions were extruded and pelletized. The pellets were dried for 8 hours at 120° C. and then injection molded.

The polymer compositions were tested for tensile properties and notched Charpy. Tensile modulus and stress at break were tested according to ISO Test 527 at a temperature of 23° C. and a test speed of 5 mm/mins using standard ISO test specimens. Notched Charpy impact strength was determined according to ISO Test No. 179-1 at 23° C. Stick-slip tests were also conducted on the polymer compositions to determine the dynamic coefficient of friction, abrasion or wear, and noise generation. Stick-slip tests were conducted according to VDA 230-206. A ball-on-plate configuration was utilized with a load of 30 N, a sliding speed of 8 mm/s, and a test duration of 1,000 cycles. A noise rating test was conducted. A noise rating of 1 to 3 represents no noise risk. A noise rating of 4 to 5 represents a low noise risk. A noise rating of 6 to 10, on the other hand, represents a high noise risk.

The following polymer compositions were formulated and the following test results were obtained.

| | Sample 1 | Sample 2 | Sample 3 | Sample 4 | Sample 5 |
|---|---|---|---|---|---|
| | (%) | (%) | (%) | (%) | (%) |
| Graft copolymer of a | 5 | — | 5 | 2.5 | — |
| polyethylene and a | | | | | |
| styrene acrylonitrile | | | | | |
| polymer | | | | | |
| UHMW polyethylene | — | 3.5 | 7 | 3.5 | 7 |
| particles (GUR 4120) | | | | | |
| UHMW-Si (wt. %) | — | 3.0 | — | — | — |
| Coupling Agent | 0.5 | 0.5 | 0.5 | 0.5 | 0.5 |
| Glass Fibers | 14.69 | 15.64 | 14.66 | 14.75 | 14.75 |
| POM copolymer and | remainder | remainder | remainder | remainder | remainder |
| stabilizers (wt. %) | | | | | |

| | | Sample 1 | Sample 2 | Sample 3 | Sample 4 | Sample 5 |
|---|---|---|---|---|---|---|
| Tensile Modulus (MPa) | | 6113 | 5765 | 5553 | 5912 | 5658 |
| Stress at Break (MPa) | | 115.79 | 104.15 | 97.95 | 107.96 | 101.48 |
| Strain at Break | | 3.64% | 3.5% | 3.58% | 3.72% | 3.79% |
| Notched Charpy (kJ/m²) | | 10.0 | 10.8 | 8.9 | 9.2 | 9.3 |
| Stick-slip | Dynamic | .221 | .286 | .215 | .279 | .295 |
| | CoF | | | | | |
| | Depth of | 25 | 26 | 22 | 49 | 188 |
| | wear | | | | | |
| | (microns) | | | | | |
| | Noise | 3 | 4 | 5 | 7 | 9 |
| | rating | | | | | |

| | | | | | |
|---|---|---|---|---|---|
| Melt volume ratio | 1.95 | 1.64 | 0.82 | 1.57 | 1.23 |
| (cm³/10 min) | | | | | |
| Heat distortion | 161 | 160.7 | 158.6 | 159.8 | 159.7 |
| temperature (HDT-A) | | | | | |
| (° C.) | | | | | |

As shown above, the use of the graft copolymer dramatically improved noise properties when tested against car glass.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part.

Furthermore, those of ordinary skill in the art will appreciate that the foregoing description is by way of example only, and is not intended to limit the invention so further described in such appended claims.

1.-21. (canceled)

22. A window system for a vehicle comprising:
a window;
a track;
a glass carrier located along the track and in contact with the window;
a motor in operative association with the glass carrier for opening and closing the window; and
wherein the glass carrier in contact with the window is made from a polymer composition comprising:
a polyoxymethylene polymer, the polyoxymethylene polymer including reactive groups at terminal positions of the polymer, the reactive groups comprising hydroxyl groups, and wherein the hydroxyl groups are present on the polyoxymethylene polymer in an amount greater than about 15 mmol/kg, the polyoxymethylene polymer being present in the composition in an amount from about 50% by weight to about 90% by weight;
reinforcing fibers present in the polymer composition in an amount from about 10% to about 30% by weight;
a tribological modifier comprising a graft copolymer of a polyethylene and a styrene acrylonitrile, the tribological modifier being present in the composition in an amount of from 3% by weight to less than 7% by weight;
a coupling agent comprising an isocyanate, the coupling agent being present in the polymer composition in an amount from about 0.1% to about 1% by weight;
wherein the polymer composition has a dynamic coefficient of friction against the glass of less than about 0.25 as determined according to VDA 230-206 and a noise rating of less than about 4; and
wherein the graft copolymer is the only tribological modifier present in the polymer composition.

23. A window system as defined in claim 22, wherein the composition does not contain any silicone polymers.

24. A window system as defined in claim 22, wherein the polymer composition has a heat distortion temperature (HDT-A) of greater than 160° C. when tested at 1.8 MPa.

25. A window system as defined in claim 22, wherein the polymer composition exhibits a wear track according to VDA 230-206 of less than 50 microns and exhibits a dynamic coefficient of friction according to VDA 230-206 of from about 0.15 to about 0.25.

26. A window system as defined in claim 22, wherein the polymer composition has a melt volume flow rate of from about 0.5 cm³/10 min to about 2.5 cm³/10 min when measured at 190° C. and at a load of 2.16 kg.

27. A window system as defined in claim 22, wherein the polymer composition further contains a benzophenone, a benzotriazole, or a benzoate in an amount from about 0.01% by weight to about 0.75% by weight.

28. A window system as defined in claim 22, wherein the polymer composition further contains a calcium salt in an amount from about 0.001% by weight to less than 1% by weight.

29. A window system as defined in claim 22, wherein the polymer composition further contains an oligomeric hindered amine in an amount from about 0.01% by weight to about 0.75% by weight.

30. A window system for a vehicle comprising:
a track;
a glass carrier located within the track;
a motor in operative association with the glass carrier for moving the glass carrier along the track; and
wherein the glass carrier is made from a polymer composition comprising:
a polyoxymethylene polymer, the polyoxymethylene polymer including reactive groups at terminal positions of the polymer, the reactive groups comprising hydroxyl groups, and wherein the hydroxyl groups are present on the polyoxymethylene polymer in an amount greater than about 15 mmol/kg, the polyoxymethylene polymer being present in the composition in an amount from about 50% by weight to about 90% by weight;
reinforcing fibers present in the polymer composition in an amount from about 10% to about 30% by weight;
a tribological modifier comprising a graft copolymer of a polyethylene and a styrene acrylonitrile, the tribological modifier being present in the composition in an amount of from 3% by weight to less than 7% by weight;
a coupling agent comprising an isocyanate, the coupling agent being present in the polymer composition in an amount from about 0.1% to about 1% by weight;
wherein the polymer composition has a dynamic coefficient of friction against car glass of less than about 0.25 as determined according to VDA 230-206 and a noise rating of less than about 4;
wherein the polymer composition has a melt volume flow rate of from about 0.5 cm³/10 min to about 2.5 cm³/10 min when measured at 190° C. and at a load of 2.16 kg and wherein the polymer composition has a heat distortion temperature (HDT-A) of greater than 160° C. when tested at 1.8 MPa; and
wherein the graft copolymer is the only tribological modifier present in the polymer composition.

31. A window system as defined in claim 30, wherein the composition does not contain any silicone polymers.

32. A window system as defined in claim 30, wherein the polymer composition exhibits a wear track according to VDA 230-206 of less than 50 microns and exhibits a dynamic coefficient of friction according to VDA 230-206 of from about 0.15 to about 0.25.

33. A window system as defined in claim 30, wherein the polymer composition further contains a benzophenone, a benzotriazole, or a benzoate in an amount from about 0.01% by weight to about 0.75% by weight.

34. A window system as defined in claim 30, wherein the polymer composition further contains a calcium salt in an amount from about 0.001% by weight to less than 1% by weight.

35. A window system as defined in claim 30, wherein the polymer composition further contains an oligomeric hindered amine in an amount from about 0.01% by weight to about 0.75% by weight.
